(19) United States
(12) Patent Application Publication
(10) Pub. No.: US 2012/0077281 A1
(43) Pub. Date: Mar. 29, 2012

(54) Antioxidant Test Device

(76) Inventors: John Harley Loveless BEAL, Wellington (NZ); Paul Frank DAVIS, Wellington (NZ)

(21) Appl. No.: 13/241,158

(22) Filed: Sep. 22, 2011

Related U.S. Application Data
(60) Provisional application No. 61/385,972, filed on Sep. 24, 2010.

(51) Int. Cl. G01N 21/78

(52) U.S. Cl. 436/169

(57) ABSTRACT

The invention relates to a device for estimating total antioxidant capacity (TAC) of a range of fluids and extracts. More particularly the invention relates to a device where the TAC is measured using lateral flow technology on a solid support. For example, the device may be a test strip.

### RELATED APPLICATION

This application claims the benefit of U.S. Application No. 61/385,972 filed Sep. 24, 2010, which is hereby incorporated herein by reference in its entirety.

### FIELD OF THE INVENTION

This invention relates to a device for estimating total antioxidant capacity (TAC) of a range of fluids and extracts. More particularly the invention relates to a device where the TAC is measured using lateral flow technology on a solid support.

### BACKGROUND

For various reasons it may be useful and important to ascertain the levels of antioxidant in a sample. Chemical radicals occur as a result of various biological processes. These radicals can damage cellular structures and therefore cause serious health issues. One way of combating damage caused by oxidation is the consumption of food or drink that has antioxidant properties. Because there is a demand to consume antioxidants to decrease the effects of oxidation on cellular processes, many manufacturers produce antioxidant nutritional supplements. However, there remains the problem of being able to easily and quickly determine the antioxidant capacity of a food, drink or other type of antioxidant source.

Current methods for determining the antioxidant capacity of a food or drink sample may be out of reach for some people because they do not have ready access to the necessary scientific apparatus or technical knowledge for carrying out the methods. Historically, to determine the level of antioxidant in a sample, extensive laboratory based chemistry would need to be carried out requiring access to, and the use of, specific chemicals.

One technique to measure antioxidant capacity of a sample is described in the publications of Apak and co-workers (R. Apak, K. Güçlü, M. Özyürek and S. E. Karademir, J. Agric. Food. Chem., 2004, 52, 7970 and E. Tütem, R. Apak and F. Baykut, Analyst, 1991, 116, 89). This technique is based on the colorimetric determination of the concentration of a chromophoric copper(I) complex, bis(2,9-dimethyl-1,10-phenanthrolino)copper(I). This complex is produced by reduction of the copper(II) complex, bis(2,9-dimethyl-1,10-phenanthrolino)copper(II), by redox-active antioxidant compounds. The colorimetric change of the copper(II) complex to the copper(I) complex is an indicator of the antioxidant concentration.

The TAC of a sample can be assessed using this method by comparing the absorbance at 450 nm of the copper(I) complex produced by reaction with the sample compared to the absorbance of the copper(I) complex produced by reaction with a series of solutions with known concentrations of a standard antioxidant reference compound. The TAC of antioxidant source is typically expressed in units of equivalent concentration of the standard antioxidant compound.

This assay methodology has been shown to be applicable to an extensive range of endogenous and exogenous antioxidant sources (R. Apak, K. Güçlü, M. Özyürek and S. E. Karademir, J. Agric. Food. Chem., 2004, 52, 7970, R. Apak, K. Güçlü, B. Demirata, M. Özyürek, S. E. [symbol] elik, B. Bekta [symbol] o\check{g}lu, K. I. Berker and D. Özyurt, Molecules, 2007, 12, 1496, M. Özyürek, B. Bekta [symbol] o\check{g}lu, K. Güçlü, N. Güngör and R. Apak, Anal. Chim. Acta, 2008, 630, 28), including biological fluids (R. Apak, K. Güçlü, M. Özyürek, S. E. Karademir and M. Altun, Free Radical Res., 2005, 39, 949) and extracts (M. Özyürek, B. Bekta [symbol] o\check{g}lu, K. Güçlü, N. Güngör and R. Apak, Anal. Chim. Acta, 2008, 630, 28).

The first application of lateral flow technology was made in 1980 in an assay for human chorionic gonadotropin (HCG) to test for pregnancy (B. Ngom, Y. Guo, X. Wang and D. Bi, Anal. Bioanal. Chem., 2010, 397, 1113). Since then lateral flow tests have been developed for a wide range of analytes, including infectious agents (bacteria, viruses, fungal toxins), pesticide and antibiotic residues, and drugs of abuse (A. Volkov, M. Mauk, C. Paul and R. S. Niedbala, in Methods in Molecular Biology, eds. A. Rasooly and K. E. Herold, Humana Press Inc., Totowa, 2009, pp. 217).

The most common format (sandwich immunochromatographic assay) involves an antibody labelled with a marker such as colloidal gold, which flows along the test strip by capillary action. When antigen (analyte) is present, an antigen-antibody-marker complex forms, which is then captured by a line of capture antibodies, leading to the formation of a visible band at the test line, indicating a positive result. In addition, a ‘control’ line using an appropriate antibody serves to capture any marker which has not encountered analyte, forming a visible band at the control position. This provides an indication of the correct functioning of the test.

The known methods of antioxidant testing include a wet, solution-based reaction involving handling and accurately measuring amounts of chemicals. Such methods are suitable for a laboratory environment, and it is therefore difficult or impossible for consumers to quickly and easily determine the antioxidant capacity of a food, drink or any other sample in which they are interested. It is normally not possible for a consumer to do this at home.

To date there has been no application of lateral flow testing technology to antioxidant testing as a means to avoid the complications and costs associated with traditional wet chemistry laboratory testing for TAC.

It is therefore an object of the invention to provide an antioxidant test device which will at least go part way to overcoming one or more of the above difficulties and disadvantages, or to at least provide a useful alternative to existing antioxidant testing methodologies.

### SUMMARY OF THE INVENTION

In a first aspect of the invention there is provided a device for detecting the presence of one or more antioxidants in a liquid sample, where the device comprises:
a) a matrix capable of supporting one or more chemical substances;
b) chemical A supported at a first location on the matrix;
c) chemical B supported at a second location on the matrix, where chemical B is capable of reacting with chemical A to give chemical C;
   where the sample, when applied to the matrix, travels along or within the matrix to the first location, and then the sample and chemical A travel along or within the matrix to the second location where chemical A reacts with chemical B to give chemical C and where the one or more antioxidants in the sample react with chemical C to give chemical D, where the presence of chemical D can be detected.

In a second aspect of the invention there is provided a device for detecting the presence of one or more antioxidants in a liquid sample, where the device comprises:
a) a matrix capable of supporting one or more chemical substances;
b) chemical B supported at a first location on the matrix;
c) chemical A supported at a second location on the matrix, where chemical A is capable of reacting with chemical B to give chemical C;
   where the sample, when applied to the matrix, travels along or within the matrix to the first location, and then the sample and chemical B travel along or within the matrix to the second location where chemical A reacts with chemical B to give chemical C and where the one or more antioxidants in the sample react with chemical C to give chemical D, where the presence of chemical D can be detected.

In a third aspect of the invention there is provided a device for detecting the presence of one or more antioxidants in a liquid sample, where the device comprises:
a) a matrix capable of supporting one or more chemical substances;
b) chemical B supported at a first location on the matrix;
c) chemical A supported at a second location on the matrix;
   where the sample, when applied to the matrix, travels along or within the matrix to the first location, and then the sample and chemical B travel along or within the matrix to the second location where chemical A reacts first with the one or more antioxidants in the sample and then with chemical B to give chemical D, where the presence of chemical D can be detected.

In a fourth aspect of the invention there is provided a device for detecting the presence of one or more antioxidants in a liquid sample, where the device comprises:
a) a matrix capable of supporting one or more chemical substances;
b) chemical A supported at a first location on the matrix;
c) chemical B supported at a second location on the matrix;
   where the sample, when applied to the matrix, travels along or within the matrix to the first location, and then the sample and chemical A travel along or within the matrix to the second location where chemical A reacts first with the one or more antioxidants in the sample and then with chemical B to give chemical D, where the presence of chemical D can be detected.

In a fifth aspect of the invention there is provided a device for detecting the presence of one or more antioxidants in a liquid sample, where the device comprises:
a) a matrix capable of supporting one or more chemical substances;
b) chemical A and chemical B supported at a first location on the matrix;
   where the sample, when applied to the matrix, travels along or within the matrix to the first location, and then chemical A reacts first with the one or more antioxidants in the sample and then with chemical B to give chemical D, where the presence of chemical D can be detected.

Preferably chemical A is a metal salt such as a transition metal salt, e.g. a copper salt, for example copper(II) chloride, or an iron(III) salt, for example iron(III) chloride.

Chemical B is preferably a ligand which can coordinate to a metal ion. In some examples, chemical B is a chelating agent. A preferred example is 2,9-dimethyl-1,10-phenanthroline, which may be in the form of a salt and/or hydrate thereof. Alternatively preferably, chemical B can be the chelating agent 2,4,6-tripyridyl-s-triazine. Where chemical A is copper(II) chloride and chemical B is 2,9-dimethyl-1,10-phenanthroline, chemical C is therefore bis(2,9-dimethyl-1,10-phenanthrolino)copper(II) (with chloride counter ions) and chemical D is bis(2,9-dimethyl-1,10-phenanthrolino)copper(I) (with chloride counter ions). Where chemical A is iron(III) chloride and chemical B is 2,4,6-tripyridyl-s-triazine, chemical D is bis(2,4,6-tripyridyl-s-triazine)iron(II) (with chloride counter ions).

In some examples chemical A and chemical B are loaded separately onto the matrix.

Alternatively, in some examples of the fifth aspect of the invention, chemical A and chemical B may be combined together and then loaded onto the matrix.

In a preferred embodiment of the invention the matrix is a membrane, e.g. a nitrocellulose membrane, and may be provided with a support, e.g. a backing such as a film, e.g. a polymer support film. In a preferred embodiment of the invention an absorbent pad may be affixed to the matrix.

Chemical A is preferably located on the matrix in a band lateral to the direction of movement of sample along or within the matrix. Similarly, chemical B is preferably located on the matrix in a band lateral to the direction of movement of sample along or within the matrix.

The device may have any dimensions suitable for use, but is preferably in the form of a strip which is substantially rectangular in shape. Where the device is substantially rectangular in shape it preferably has the following dimensions: width 2-50 mm; length 20-100 mm. Alternatively, the device may be substantially tubular in shape. Where the device is substantially tubular in shape it has the following dimensions: diameter 1-50 mm; length 20-100 mm.

Preferably the location of chemical A on the matrix is between the location where the sample is applied to the matrix and the location of chemical B on the matrix. More preferably chemical A is located about 10 mm from the location where the sample is applied, and chemical B is located about 15 mm from the location where the sample is applied.

Alternatively it is preferred that the location of chemical B on the matrix is between the location where the sample is applied to the matrix and the location of chemical A on the matrix More preferably chemical B is located about 10 mm from the location where the sample is applied, and chemical A is located about 15 mm from the location where the sample is applied.

Alternatively it is preferred that the locations of chemical B and chemical A on the matrix are substantially the same. More preferably chemical A and chemical B are located together, about 10-15 mm from the location where the sample is applied to the matrix.

The presence of chemical D is preferably detected by colour change, but may be detected by any other suitable detection method. For example, where chemical D is bis(2,9-dimethyl-1,10-phenanthrolino)copper(I), a colour change to a yellow-orange colour can be detected. Where chemical D is bis(2,4,6-tripyridyl-s-triazine)iron(II), a colour change to a blue colour can be detected.

In a further aspect of the invention there is provided the use of the device of the first, second, third, fourth or fifth aspect of the invention for the detection of an antioxidant in a sample.

In a preferred embodiment of this aspect of the invention, the sample is applied to one end of the device, the sample then travels along or within the matrix to the first location, and then the sample and chemical A travel along or within the matrix to the second location where chemical A reacts with chemical B to give chemical C and where the one or more antioxidants in the sample react with chemical C to give chemical D, and the presence of chemical D is detected.

In an alternative preferred embodiment of this aspect of the invention, the sample is applied to one end of the device, the sample then travels along or within the matrix to the first location, and then the sample and chemical B travel along or within the matrix to the second location where chemical B reacts with chemical A to give chemical C and where the one or more antioxidants in the sample react with chemical C to give chemical D, and the presence of chemical D is detected.

In another alternative preferred embodiment of this aspect of the invention, the sample is applied to one end of the device, the sample then travels along or within the matrix to the first location, and then the sample and chemical B travel along or within the matrix to the second location where chemical A reacts first with the one or more antioxidants in the sample and then with chemical B to give chemical D, and the presence of chemical D is detected.

In another alternative preferred embodiment of this aspect of the invention, the sample is applied to one end of the device, the sample then travels along or within the matrix to the first location, and then the sample and chemical A travel along or within the matrix to the second location where chemical A reacts first with the one or more antioxidants in the sample and then with chemical B to give chemical D, and the presence of chemical D is detected.

In still another alternative preferred embodiment of this aspect of the invention, the sample is applied to one end of the device, the sample then travels along or within the matrix to the first location, and then chemical A reacts first with the one or more antioxidants in the sample and then with chemical B to give chemical D, and the presence of chemical D is detected.

In another aspect of the invention there is provided a method of determining the presence of an antioxidant in a sample using the device of the first aspect of the invention.

The invention furthermore provides:
(1) A device for detecting the presence of one or more antioxidants in a liquid sample, where the device comprises:
   a) a matrix capable of supporting one or more chemical substances;
   b) chemical A supported at a first location on the matrix;
   c) chemical B supported at a second location on the matrix, where chemical B is capable of reacting with chemical A to give chemical C;
   where the sample, when applied to the matrix, travels along or within the matrix to the first location, and then the sample and chemical A travel along or within the matrix to the second location where chemical A reacts with chemical B to give chemical C and where the one or more antioxidants in the sample react with chemical C to give chemical D, where the presence of chemical D can be detected.
(2) A device for detecting the presence of one or more antioxidants in a liquid sample, where the device comprises:
   a) a matrix capable of supporting one or more chemical substances;
   b) chemical B supported at a first location on the matrix;
   c) chemical A supported at a second location on the matrix, where chemical A is capable of reacting with chemical B to give chemical C;
   where the sample, when applied to the matrix, travels along or within the matrix to the first location, and then the sample and chemical B travel along or within the matrix to the second location where chemical A reacts with chemical B to give chemical C and where the one or more antioxidants in the sample react with chemical C to give chemical D, where the presence of chemical D can be detected.
(3) A device for detecting the presence of one or more antioxidants in a liquid sample, where the device comprises:
   a) a matrix capable of supporting one or more chemical substances;
   b) chemical B supported at a first location on the matrix;
   c) chemical A supported at a second location on the matrix;
   where the sample, when applied to the matrix, travels along or within the matrix to the first location, and then the sample and chemical B travel along or within the matrix to the second location where chemical A reacts first with the one or more antioxidants in the sample and then with chemical B to give chemical D, where the presence of chemical D can be detected.
(4) A device for detecting the presence of one or more antioxidants in a liquid sample, where the device comprises:
   a) a matrix capable of supporting one or more chemical substances;
   b) chemical A supported at a first location on the matrix;
   c) chemical B supported at a second location on the matrix;
   where the sample, when applied to the matrix, travels along or within the matrix to the first location, and then the sample and chemical A travel along or within the matrix to the second location where chemical A reacts first with the one or more antioxidants in the sample and then with chemical B to give chemical D, where the presence of chemical D can be detected.
(5) A device for detecting the presence of one or more antioxidants in a liquid sample, where the device comprises:
   a) a matrix capable of supporting one or more chemical substances;
   b) chemical A and chemical B supported at a first location on the matrix;
   where the sample, when applied to the matrix, travels along or within the matrix to the first location, and then chemical A reacts first with the one or more antioxidants in the sample and then with chemical B to give chemical D, where the presence of chemical D can be detected.
(6) The device of any of the above (1) to (5) where chemical A is a metal salt.
(7) The device of the above (6) where the metal salt is a copper(II) salt.
(8) The device of any of the above (1) to (7) where chemical B is a chelating agent.
(9) The device of the above (8) where the chelating agent is 2,9-dimethyl-1,10-phenanthroline, or a salt or hydrate thereof.
(10) The device of the above (9) where chemical C is bis(2,9-dimethyl-1,10-phenanthrolino)copper(II).
(11) The device of the above (10) where chemical D is bis(2,9-dimethyl-1,10-phenanthrolino)copper(I).
(12) The device of any of the above (1) to (11) where the matrix is a nitrocellulose membrane.
(13) The device of the above (12) where the nitrocellulose membrane is provided with a polymer support film.
(14) The device of the above (13) further comprising an absorbent pad attached to the matrix.
(15) The device of any of the above (1) to (14) where the chemical A is located on the matrix in a band lateral to the direction of movement of sample along or within the matrix.
(16) The device of the above (15) where the chemical B is located on the matrix in a band lateral to the direction of movement of sample along or within the matrix.
(17) The device of the above (1) to (16) which is substantially rectangular in shape and is 2 to 50 mm wide and 20 to 100 mm long, or is substantially tubular in shape and is 1 to 50 mm in diameter and 20 to 100 mm long.
(18) The device of the above (1) where the location of chemical A is between the location where the sample is applied and the location of chemical B.
(19) The device of the above (18) where chemical A is located about 10 mm from the location where the sample is applied.
(20) The device of the above (19) where chemical B is located about 15 mm from the location where the sample is applied.
(21) The device of any of the above (1) to (20) where chemical D is detected by colour change.
(22) The use of the device of any of the above (1) to (21) for the detection of an antioxidant in a sample.
(23) The use of the above (22) where the sample is applied to one end of the device, the sample then travels along or within the matrix to the first location, and then the sample and chemical A travel along or within the matrix to the second location where chemical A reacts with chemical B to give chemical C and where the one or more antioxidants in the sample react with chemical C to give chemical D, and the presence of chemical D is detected.

### DESCRIPTION OF THE FIGURES

FIG. 1 shows a preferred device configuration.

FIG. 2 shows progression of solvent along a preferred device. lmm. denotes approximate depth to which strip is immersed in 1 mM ascorbic acid in ammonium acetate buffer (incl. 10% v/v ethanol).

A) Before immersion of base in solvent.

B) Solvent front passing copper(II) chloride band at position (a). An arrow marks the blue band of dissolved copper(II) chloride at the solvent front.

C) Solvent front passed into absorbent pad.

FIG. 3 shows the effect of deposition of either one or two aliquots of each chemical (copper (II) chloride and 2,9-dimethyl-1,10-phenanthroline) onto membrane. (A) one aliquot (B) two aliquots. Where (a) and (b) denote positions (a) and (b), respectively, as shown in FIG. 1.

FIG. 4 provides an example chart for quantification of TAC, where the corresponding equivalent standard antioxidant concentrations (ascorbic acid) are given in FIG. 6b.

FIG. 5 shows a densitometric determination of chromophore intensity A) RGB image of device. B) 8-bit image of device with selected area. C) densitometric profile of selected area.

FIG. 6a shows a preferred configuration of the device tested against ascorbic acid standards (0-10 mM in 1 M pH 7 ammonium acetate buffer).

FIG. 6b shows the response of a preferred configuration of the device to ascorbic acid standards.

FIG. 7a shows a preferred configuration of the device tested against urine at A) no dilution, B) 1:2, C) 1:4, D) 1:8, E) 1:10, F) 1:20, G) 1:40 dilution with ammonium acetate buffer. All solutions contain 10% v/v ethanol.

FIG. 7b shows the response of a preferred configuration of the device to diluted urine.

FIG. 8a shows the preferred configuration of the device tested with saliva at A) no dilution B) 1:2 C) 1:4 D) 1:8 E) 1:10 F) 1:20 G) 1:40 dilution with ammonium acetate buffer. All solutions contain 10% v/v ethanol.

FIG. 8b shows the response of preferred configuration of the device to diluted saliva.

FIG. 9a shows a preferred configuration of the device tested with serum at A) 3:2 (dilution factor 1.66); B) 1:2 (dilution factor 2); C) 2:3 (dilution factor 2.5) dilution with ammonium acetate buffer. All solutions contain 10% v/v ethanol.

FIG. 9b shows the response of a preferred configuration of the device to diluted serum.

FIG. 10a shows a preferred configuration of the device tested with plasma at A) 3:2 (dilution factor 1.66); B) 1:2 (dilution factor 2); C) 2:3 (dilution factor 2.5) dilution with ammonium acetate buffer. All solutions contain 10% v/v ethanol.

FIG. 10b shows the response of the preferred configuration of the device with diluted plasma.

### DETAILED DESCRIPTION

The inventors have found that an antioxidant test device (e.g. a test strip) can be created that allows the measurement of the TAC of a sample. Surprisingly, the inventors have found that detection chemistry which previously has only been known for wet chemistry applications can actually be achieved by loading reagents on a matrix, e.g. a membrane, optionally provided with a support, e.g. a backing which is a polymer support film. A sample to be tested can be applied to the matrix. The sample then interacts with the chemical reagents as the sample travels on or through the matrix. A user of the device is not required to handle chemical reagents. Advantageously, this allows the antioxidant capacity of a sample to be determined almost anywhere (not necessarily in a laboratory) and by any person wishing to do so (not necessarily a person with scientific training).

As used herein, the term “TAC” means the total concentration of all antioxidant compounds within a sample.

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

The matrix can be any suitable material onto which chemicals A and B can be loaded, and through or along which the sample to be tested can travel. Suitable materials include membranes. The matrix is optionally provided with a support, e.g. a polymer film support.

In one embodiment of the invention, the device is in the form of a test strip. It will be appreciated by those skilled in the art that any type or shape of device that allows the flow of a sample will be suitable. Thus, the device can, for example, be in the form of a tube, strip, film, membrane or any other shaped device through or along which the sample to be tested can travel. Suitable types of devices include capillary tubes, chromatography columns or films. In a particularly preferred embodiment the matrix, e.g. a membrane, is supported on a film, e.g. a polymer support film, and the device is a test strip.

Examples of membranes that can be used in the device of the invention include those onto which a solution, e.g. an aqueous solution, an aqueous/ethanol solution or an ethanol solution, preferably an aqueous solution, of a metal salt and/or a ligand, such as a chelating agent, can be loaded. Those skilled in the art will understand that there are a variety of membranes that can be used, depending on the nature of the chemicals A and B. Nitrocellulose membranes are particularly preferred. Further, to assist in the movement of the sample it may be preferable to have an absorbent pad attached to the membrane to facilitate the capillary action. In a preferred embodiment, the membrane is HiFlow™ Plus 240 (HF240) supplied by Millipore Corporation, MA, USA.

An absorbent pad is preferably affixed to the matrix, e.g. the membrane, to facilitate transport of the sample over or through the membrane. It will be appreciated that the absorbent pad may be made of a variety of materials, particularly cellulose fibre, or any other type of porous material.

In a preferred embodiment, during the passage of the sample through or along the matrix, e.g. the membrane, observation of the passage of a blue band of copper(II) chloride up the membrane into the absorbent pad serves as an indicator of the correct functioning of the device (thus acting as a control indicator).

Where the device is a test strip, a sample applied to the test strip will typically move along the strip by capillary action, although those skilled in the art will also appreciate that the sample may flow along, down or through the device by way of gravity.

In some embodiments, a reduction-oxidation reaction takes place when antioxidants in the sample come into contact with chemicals A and B that have been loaded onto the matrix. The chemical D that is produced can be detected, e.g. by a colour change.

In a preferred embodiment, the colour change may be caused by reaction involving chemical C, which may be a transition metal complex, and an antioxidant. For example, if chemical C is a transition metal complex the oxidation state of the transition metal is changed (reduced). When chemical C is a transition metal complex, it is preferred that the standard reduction potential of the chemical C/chemical D couple is between about +0.3 V to about +0.9 V, e.g. about +0.6 V. For example, the transition metal may be copper, e.g. chemical A is preferably copper(II) chloride. Other types of transition metals may also be used, such as iron(III) salts, e.g. iron(III) chloride.

It is preferred that chemical B is a ligand such as a chelating ligand, e.g. a chelating agent that, when bound to a suitable transition metal salt such as copper(II), produces a transition metal complex having a reduction potential that falls within the range of about +0.3 V to about +0.9 V. Where chemical A is a copper(II) salt, it is preferred that chemical B is a strongly electron donating ligand, e.g. an electron donating chelating agent such as 2,9-dimethyl-1,10-phenanthroline. Other suitable chelating agents that may be used in the device of the invention include 2,9-dimethyl-4,7-diphenyl-1,10-phenanthroline, or 2,9-dimethyl-4,7-diphenyl-1,10-phenanthrolinedisulfonic acid (which can be stored as the disodium salt). Suitable chelating agents that may be used where chemical A is an iron(III) salt include 2,4,6-tripyridyl-s-triazine, 3-(2-pyridyl)-5,6-bis(4-phenylsulfonic acid)-1,2,4-triazine (which can be stored as the disodium salt), 2,2′-bipyridine, 2,6-bis(2-pyridyl)-pyridine, phenyl 2-pyridyl ketoxime, 1,10-phenanthroline, 4,7-diphenyl-1,10-phenanthroline or 4,7-diphenyl-1,10-phenanthrolinedisulfonic acid (which can be stored as the disodium salt). One or more such chelating agents may bind to the suitable transition metal salt (chemical A), such that chemicals C and D are metal complexes comprising one or more chelating agents, e.g. one to three chelating agents, typically two chelating agents.

It is further preferred that chemical D is a transition metal complex comprising one or more ligands, e.g. one or more chelating agents, which are ligands that are capable of forming metal-ligand charge transfer (MLCT) complexes with absorbances in the visible region.

During the creation of the test device chemical solutions containing chemical A and chemical B are loaded onto the matrix. The amounts of chemical A and chemical B to be applied to the test device will vary, e.g. depending on the chemicals used. Typically, where chemical A is copper(II) chloride, the amount to be applied is about 500 nmol per cm of strip width, and where chemical B is 2,9-dimethyl-1,10-phenanthroline (in some examples, the 2,9-dimethyl-1,10-phenanthroline is used as the hydrochloride hydrate), the amount to be applied is about 375 nmol per cm of strip width. One skilled in the art will realise that these concentrations are to be interpreted as a range, e.g. between about 400 to 600 nmol per cm of strip width, e.g. about 450 to 550 nmol per cm of strip width, e.g. about 500 nmol per cm of strip width (chemical A), and between about 275 to 1200 nmol per cm of strip width, e.g. about 300 to 700 nmol per cm of strip width, e.g. about 325 to 425 nmol per cm of strip width, e.g. about 375 nmol per cm of strip width (chemical B), respectively, and that the invention encompasses variations of these concentrations.

Thus, for a 5 mm strip, where chemical A is copper(II) chloride and chemical B is 2,9-dimethyl-1,10-phenanthroline, a typical amount of copper(II) chloride to apply is about 250 nmol per strip and a typical amount of 2,9-dimethyl-1,10-phenanthroline to apply is 190 nmol per strip.

Chemical A and chemical B can be applied to the test strip as solutions, e.g. aqueous solutions. Such aqueous solutions can be loaded onto a matrix in aliquots. Each aliquot of chemical A or chemical B can be loaded onto the matrix separately. Alternatively, in some embodiments, chemical A and chemical B are combined into one aliquot and loaded onto the matrix together.

In one embodiment of the invention, where chemical A is copper(II) chloride and chemical B is 2,9-dimethyl-1,10-phenanthroline hydrochloride hydrate, it is preferred that one aliquot each of chemicals A and B is applied to the test device. However, it will be appreciated that, when using different concentrations and different chemicals A and B, the number of aliquots applied to the test device may vary.

Preferred positions for the bands of copper(II) chloride and 2,9-dimethyl-1,10-phenanthroline thus loaded onto the matrix are about 10 mm and about 15 mm from the proximal end of the membrane strip, respectively.

The chromatography procedure, whereby the two reagents (chemical A and chemical B) and the analyte (antioxidant) interact by the flow of the analyte-containing running buffer along the membrane strip to produce the chromophoric response, includes variables such as the composition of the running buffer, method of applying the sample solution to the device, the duration of the run time, and the method of assessing the intensity of the chromophoric response.

Preferably chemical D is a chromophore that allows for visual detection, whereas chemical C is not strongly coloured so as not to obscure detection of chemical D. The chemical C/D couple preferably has a redox potential in an appropriate range so as to avoid reduction by other common biological, redox active, non-antioxidant compounds. In a preferred embodiment where chemical B is 2,9-dimethyl-1,10-phenanthroline hydrochloride hydrate, chemical C is bis(2,9-dimethyl-1,10-phenanthrolino)copper(II) (with chloride counter ions) and chemical D is bis(2,9-dimethyl-1,10-phenanthrolino)copper(I) (with chloride counter ions).

In some examples, reaction of chemical A with the one or more antioxidants in the sample occurs before reaction of chemical A with chemical B. In these examples, where chemical A is a transition metal and chemical B is a ligand, e.g. a chelating agent, the oxidation state of the transition metal is reduced and then the ligand coordinates to the transition metal, to give chemical D which is a transition metal complex that can be detected. In these examples, it is preferred that the transition metal standard reduction potential falls within the range of about +0.3 V to about +0.9 V.

Typically a running buffer is used to enhance the flow of the sample over or through the membrane. It will be appreciated by those skilled in the art that many different running buffers can be used with the device of the present invention. Suitable buffers include ammonium acetate (pH 7.0).

To ensure that the reduction of chemical C to chemical D by antioxidants is unaffected by variations in sample pH, samples are first diluted with a buffer solution. A preferred buffer is 1 M ammonium acetate adjusted to pH 7.0.

There are many different factors influencing the time period that the sample takes to travel along or within the matrix, e.g. the membrane. These factors include the viscosity of the sample and membrane pore size. Typically this time period will be in the range of 20 seconds to 6 minutes, preferably about 4 minutes from application of the sample. However, it will be appreciated that this may vary considerably depending on the exact location the sample is applied and the nature of the sample and of the membrane.

Advantageously, the device according to the invention can be used for measuring the TAC of a range of products of biological origin including fruits, leaves, botanicals, vegetables, beverages, foods and physiological fluids e.g. urine, serum, plasma and saliva.

### EXAMPLES

The following tests illustrate the response of the device to antioxidant solutions. The tests indicate, inter alia, that the intensity of the development of colour is proportional to the quantity of antioxidant applied to the membrane.

The device may be used to detect the presence of antioxidants in a variety of samples, and to quantify the TAC of said samples. These include various physiological fluids (such as urine, serum, plasma and saliva); and biological extracts.

This methodology can be used for measuring the antioxidant capacity of a range of products of biological origin including fruits, leaves, botanicals, vegetables, beverages, foods. Aqueous extracts of the water-soluble antioxidant compounds of said samples can be obtained and diluted with buffer until the TAC of the extract falls within the detection/quantification range of the device. It is important to ensure that the colour of said extracts does not interfere with the detection/quantification of the chromophore.

As demonstrated below, the device may be used to detect antioxidants and quantify the TAC of antioxidant-containing physiological fluids. Typically some level of dilution with buffer is required to bring the TAC of the physiological fluid within the detection/quantification range of the device. This also ensures that the assay is conducted at a consistent (neutral) pH; and that the viscosity of the sample is reduced to provide consistent flow properties.

### Example 1

### Test Strip Preparation

Copper(II) chloride dihydrate is dissolved in distilled deionised water. A preferred concentration for deposition is approximately 0.5 M. The solution is preferably filtered through a 0.22 μm nitrocellulose filter before use. 2,9-Dimethyl-1,10-phenanthroline hydrochloride hydrate (DMP) is also dissolved in distilled deionised water. A preferred concentration for deposition is approximately 0.375 M. The solution is preferably filtered through a 0.22 μm nitrocellulose filter before use.

The copper(II) chloride and DMP solutions can be dispensed using a Biodot dispensing workstation onto membrane cards as aerosols. Preferred positions for the copper(II) chloride and DMP are 10 mm and 15 mm from the proximal end of the membrane strip, respectively. A preferred membrane is the HF240 polyester-backed nitrocellulose membrane card from Millipore Corporation.

Deposition of between 0.5 μL cm⁻¹ and 4 μL cm⁻¹ (microlitres of solution dispensed per cm of membrane length) is preferable, with each of the two solutions dispensed at the same rate in each case. A preferred amount of solution to be deposited onto the membrane is 1 μL cm⁻¹. Combined with the above described concentrations, this provides preferred loadings of 500 nmol per cm of strip width and 375 nmol per cm of strip width for copper(II) chloride and DMP, respectively. The membrane cards are then preferably dried at 40° C. for one hour.

A 17 mm wide strip of absorbent cellulose fibre pad can be affixed to the self-adhesive membrane card, such that there is an approximately 2 mm overlap with the distal end of the membrane.

The remaining exposed polymer backing is then preferably cut away from the membrane card. The membrane card can be cut into 5 mm wide strips with the Biojet batch cutting system.

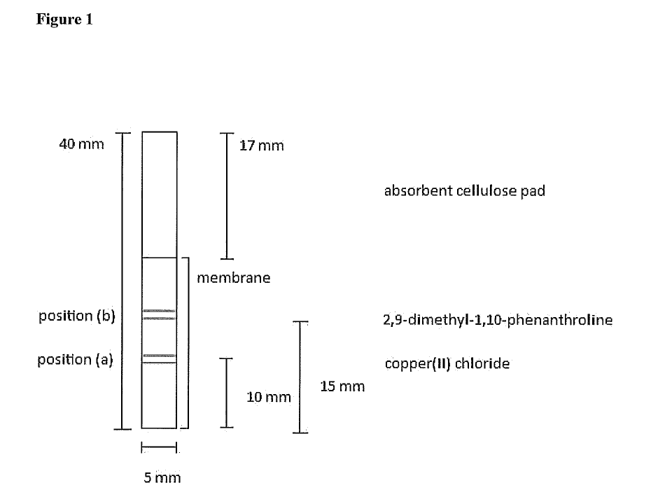

A schematic diagram of the preferred device configuration is shown in FIG. 1.

### Example 2

### Assay Procedure

Assay samples can be prepared by quantitative dilution with ammonium acetate buffer (1 M, pH 7.0). The degree of dilution required for various sample types is discussed below. The inclusion of a low percentage of ethanol aids the flow of solvent through the strip. Ethanol can be added to the diluted sample solution to give a final ethanol concentration of 10% v/v.

The device is then lowered vertically into a well containing diluted sample solution, such that the proximal end of the membrane strip is submerged to an approximate depth of 4 mm. The sample solution is observed to flow up the strip under the influence of capillary action. The device strip is left with the proximal end of the strip submerged for 2-4 minutes before being removed. A period of 4 minutes is a suitable duration of immersion when using the preferred configuration of the device.

As the solvent front passes position (a), (chemical A) green dehydrated copper(II) chloride can be observed to dissolve to form a band of blue copper(II) chloride solution, which moves with the solvent front. As the solvent front passes position (b) reaction between copper(II) chloride and (chemical B) DMP produces chemical C. In the presence of analyte (antioxidant), the production of chemical D results in the development of a colour change (orange colour) at position (b).

Excess copper(II) chloride is observed to continue to flow up the membrane strip into the absorbent pad. The passage of the blue band of copper(II) chloride up the membrane strip to the pad serves as an indicator of the correct functioning of the device.

The intensity of colour produced at, and upstream from, position (b) can be judged either by eye or by analysis of a digitised image of the strip.

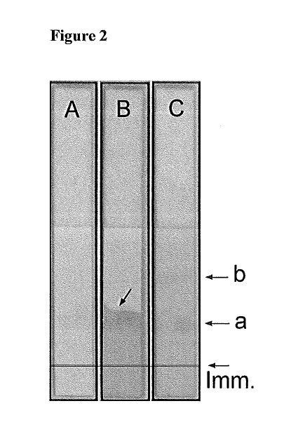

A series of photographs illustrating the observations is shown in FIG. 2.

### Example 3

### Membranes

Nitrocellulose membranes are available in various forms. One of the differentiating features is the ‘speed’ of the membrane, which determines the rate of progression of an aqueous solvent through the membrane under capillary action. Millipore Corporation labels its range of HiFlow™ Plus (HF) nitrocellulose membranes according to the time taken (in seconds) for an aqueous solution to progress a length of 4 cm (e.g. HF75 has a flow rating of 75 seconds for 4 cm).

Devices prepared from HF75, HF135 and HF240 nitrocellulose membranes are evaluated using antioxidant standard solutions and physiological fluids. HF240 is a preferred membrane when using the preferred configuration of the device, because its slower speed minimises the diffusion of chemical D after reaction of chemical C with the analyte, leading to a less diffuse, more intense result line at position (b).

### Example 4

### Reagent Deposition

Preferred positions for the reagent bands are determined to be at 10 and 15 mm from the proximal end of the membrane strip (FIG. 1). These positions allow:
Sufficient clearance between the proximal reagent band and the proximal end of the membrane strip to allow for immersion of the proximal end of the membrane strip in sample solution without submerging the reagent band.
Sufficient clearance between the two reagent bands with a solution deposition rate of 1 μL cm⁻¹.
Sufficient clearance between the distal reagent band and the absorbent pad, such that with the membrane HF240 there is no flow of chemical D off the membrane strip within a run time of 4 minutes.

Three configurations of reagent band are investigated. Configuration A, with the copper(II) chloride band proximal to the lower end of the membrane strip and distal to the absorbent pad, is a preferred configuration and is part of the preferred configuration of the device. When chemical A is copper(II) chloride and chemical B is DMP, configuration B, with DMP located proximal to the lower end of the membrane strip, is unsuitable because the superior solubility of copper(II) chloride with respect to DMP leads to the removal of copper(II) chloride from the membrane strip with the solvent front before sufficient DMP has dissolved to enable reaction with the analyte. When chemical A is copper(II) chloride and chemical B is DMP, co-deposition of copper(II) chloride and DMP (configuration C) leads to the formation of an insoluble brown precipitate on the membrane, which shows no reactivity towards analyte solution.

Deposition densities of 0.5 to 4 μL cm⁻¹ can be used to dispense copper(II) chloride and DMP solutions onto membranes, which provides reagent bands having widths of approximately 6, 4 and 2 mm for deposition of 4, 2 and 1 μL cm⁻¹, respectively. 1 μL cm⁻¹ is a preferred deposition rate, because the resulting line width of 2 mm avoids problems with overlap of the reagent bands on the membrane, or splashing of reagents from the two reagent aerosol streams.

Where chemical A is copper(II) chloride and chemical B is DMP, one application of reagents is preferable. A test device created as follows indicates this:
Copper(II) chloride and DMP solutions are dispensed onto membrane at a deposition density of 1 μL cm⁻¹.
The membrane is then dried at 40° C. for 30 minutes.
Copper(II) chloride and DMP are dispensed at 1 μL cm⁻¹ onto the membrane a second time, with each reagent band located at the same position as the first deposition.

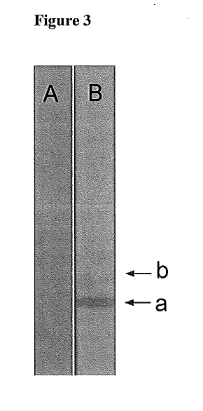

The application of a second aliquot of reagents leads to the formation of an insoluble brown precipitate at the copper(II) chloride reagent line (FIG. 3). Therefore the deposition of a single aliquot of reagent is preferred for the copper(II) chloride/DMP reagent system.

Preferred concentrations of copper(II) chloride solution and DMP solution for deposition of the reagents onto the membrane are 0.5 M and 0.375 M, respectively. These concentrations are sufficiently high to allow adequate loadings of copper(II) chloride and DMP (5×10⁻⁷ and 3.75×10⁻⁷ mol cm⁻¹, respectively) to be deposited using a single aliquot deposited at the preferred deposition of 1 μL cm⁻¹.

### Example 5

### Absorbent Pad

The device optionally contains an absorbent pad, preferably composed of cellulose fibre, which is attached to the membrane card such that the absorbent pad lies above the plane of the membrane with an approximately 2 mm lateral overlap between the pad and the distal end of the membrane strip. The optimum width of the strip is 17 mm for the preferred configuration of the device. The absorbent pad serves as a reservoir to absorb excess liquid eluting off the membrane strip, and therefore permits a continuous flow of liquid through the membrane, where otherwise flow would cease after saturation of the bed capacity of the membrane.

The presence of an absorbent pad allows a continuous flow of solvent through the membrane, such that the aliquot of sample solution which transits through the membrane is limited by the length of time the proximal end of the membrane is submerged, rather than the bed capacity of the membrane strip itself. This ensures that an equal volume is sampled in each instance, so long as the run time is held constant.

In addition, the presence of the absorbent pad enables the clearance of excess copper(II) chloride from the membrane strip, which simplifies assessment of the intensity of chemical D, by removing the confounding blue colour of the copper(II) chloride.

Sample can be administered to the device by submerging the proximal end of the membrane strip into a well containing sample solution to a depth of approximately 4 mm. The strip remains in place for a defined duration (run time), such that the device is submerged before being removed, at which time the intensity of chemical D is assessed. With an absorbent pad located at the distal end of the membrane strip, the volume of sample solution to pass through the membrane strip is constant for a given run time and membrane speed.

The time necessary for solvent to travel the length of the membrane strip is dependent on the speed of the membrane. The appropriate time periods required for solvent to flow either the distance between the immersion level (4 mm from proximal end) to the second reagent stripe at position (b) (15 mm from proximal end), or the full length of the 25 mm membrane estimated from the manufacturer's specifications are tabulated below (Table 1). The former time periods represent the minimum time necessary for the combination of both reagents and analyte, while the latter represent the minimum time necessary for excess reagents to be removed from the membrane.

Preferably, time periods greater than the minimum are required for full development of the intensity of chemical D and for clearance of excess reagents from the membrane strip. Preferred time periods durations are 180 seconds for HF75 and HF135, and 240 seconds for HF240.

TABLE 1
Duration for solvent to migrate through HF75, HF135
and HF240 membranes.

| | Approximate time | | |
|---|---|---|---|
| | to flow from | Approximate | |
| | immersion level to | time to flow | Optimum |
| | position (b) (11 mm) | full length of membrane | duration |
| Membrane | (sec) | (25 mm) (sec) | (sec) |
| HF75 | 20 | 45 | 180 |
| HF135 | 37 | 85 | 180 |
| HF240 | 66 | 150 | 240 |

### Example 6

### Assessment of Intensity of Colour of Chromophore

The assessment of the intensity of colour of chemical D on the device is made directly after the end of the allotted run duration and while the membrane strip is still wet, since drying can alter the perceived intensity of the chromophore.

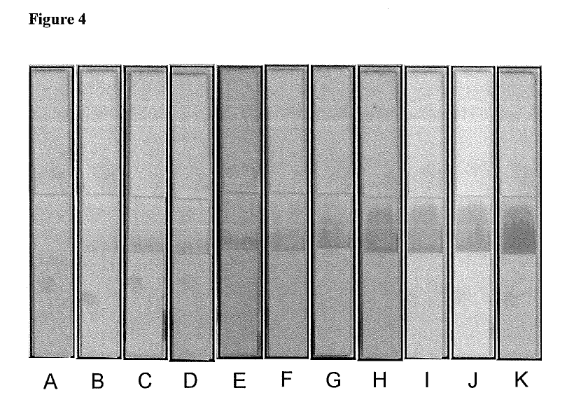

Assessment of the intensity of colour of the chromophore can be made by eye with reference to a chart such as that shown in FIG. 4. FIG. 4 shows increasing concentrations of a standard antioxidant (A to K) applied to different strips of nitrocellulose.

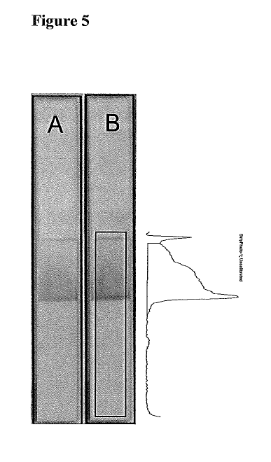

Assessment of the intensity of colour of the chromophore can also be made by densitometric measurements performed on digital photographic images of the developed device. Images are recorded on a standard digital camera (Canon EOS 20D camera with SPAF 90 mm f/2.8 macro 1:1 lens) under fluorescent illumination (8×8 W fluorescent tubes), and analysed using the ImageJ software package. Images of the developed devices are compiled into a single image file. A rectangular area from the proximal end of the membrane strip to the edge of the absorbent pad is preferably selected and converted to a densitometric profile. A baseline can then be manually inserted to estimate the background, and the area between the baseline and the profile calculated to provide a relative colour intensity measurement (see FIG. 5).

### Example 7

### Ascorbic Acid and Sodium Urate

Aliquots of a range of concentrations of ascorbic acid solution are applied to membrane strips. The responses are quantified by densitometry and there is strong dose response in the colour development.

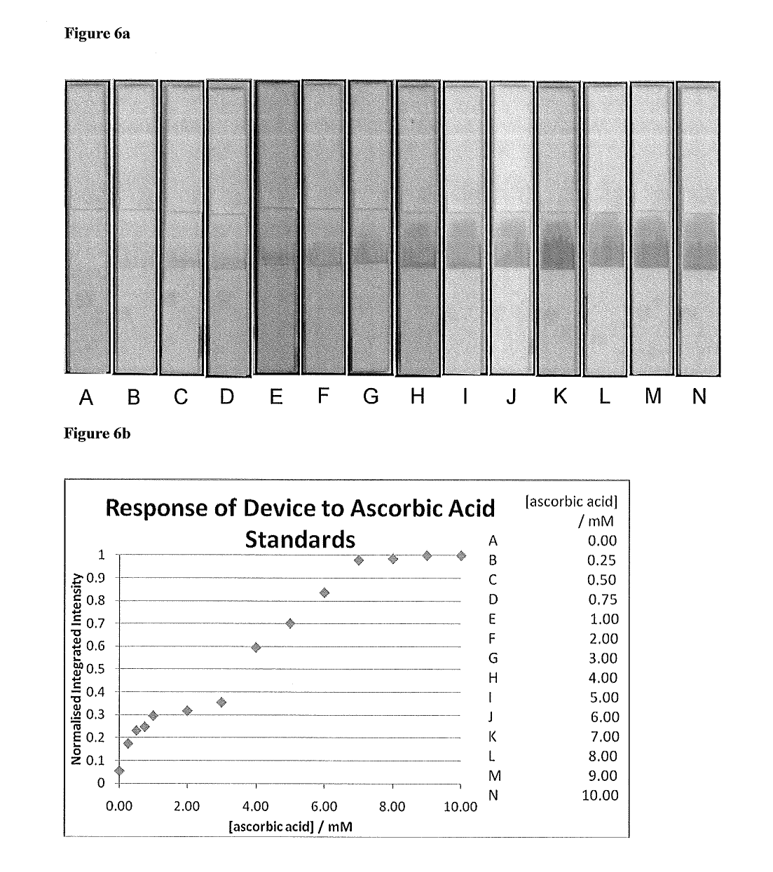

The device in the preferred configuration demonstrates a response to ascorbic acid that is linear within the concentration range of 0.25-7.00 mM. Refer to FIG. 6a for photographic images of the device tested against ascorbic acid solutions (0-10 mM), and FIG. 6b for a plot of the densitometrically determined chromophore intensity. An inflection is evident around 2 mM, with the linear gradient changing from approximately 0.14 (0-1.0 mM) and 0.22 (2.0-7.0 mM).

A similar result is obtained when sodium urate is used as the test substance.

### Example 8

### Urine

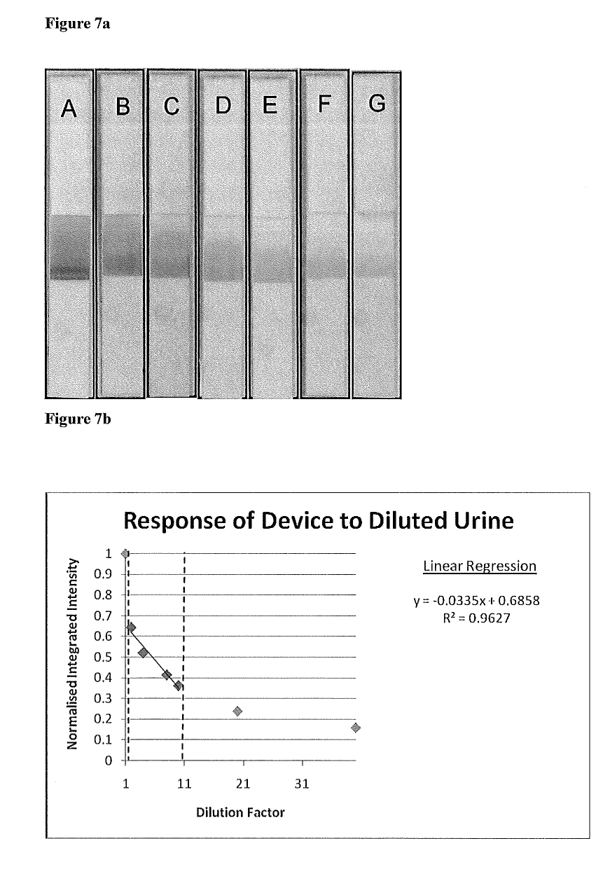

The preferred configuration of the device can be used to analyse human urine at a range of dilutions from 1:1 (undiluted urine) to 1:40 dilution with buffer. Refer to FIG. 7a for photographic images of the device tested against diluted urine samples, and FIG. 7b for a plot of the densitometrically determined chromophore intensity. The response of the device is approximately linear within the 1:2-1:10 dilution range.

### Example 9

### Saliva

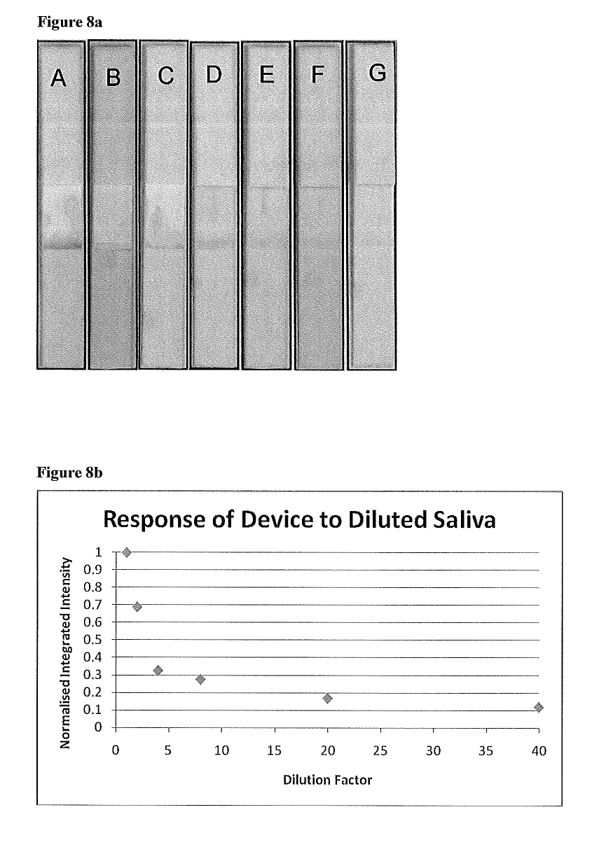

The preferred configuration of the device can be used to analyse human saliva at a range of dilutions from 1:1 (undiluted saliva) to 1:40 dilution with buffer. Refer to FIG. 8a for photographic images of the device tested against the diluted saliva samples, and FIG. 8b for a plot of the densitometrically determined chromophore intensity.

### Example 10

### Serum

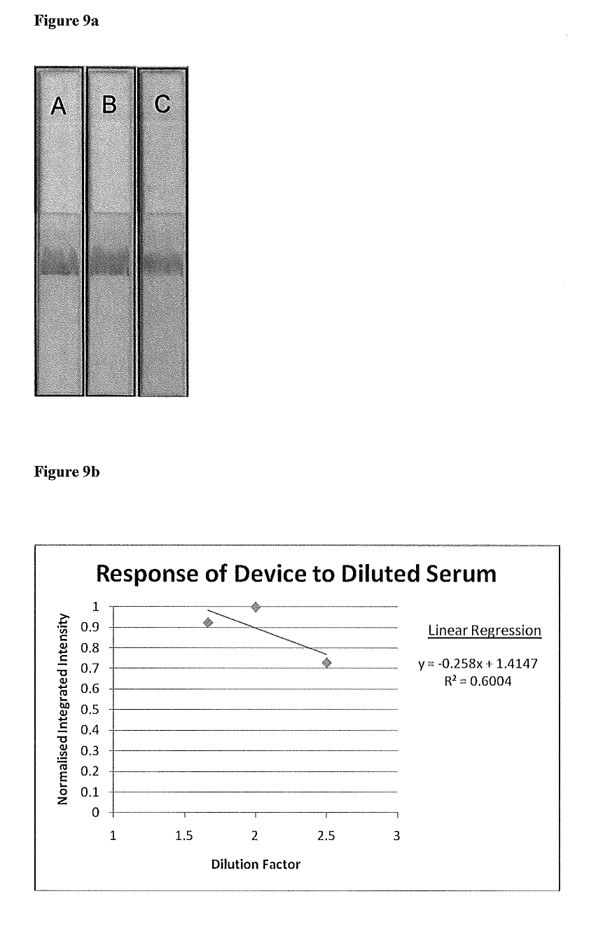

The preferred configuration of the device can be used to analyse human serum at a range of dilutions from 3:2-2:3 dilution with buffer. Refer to FIG. 9a for photographic images of the device tested against diluted serum samples, and to FIG. 9b for a plot of the densitometrically determined chromophore intensity.

### Example 11

### Plasma

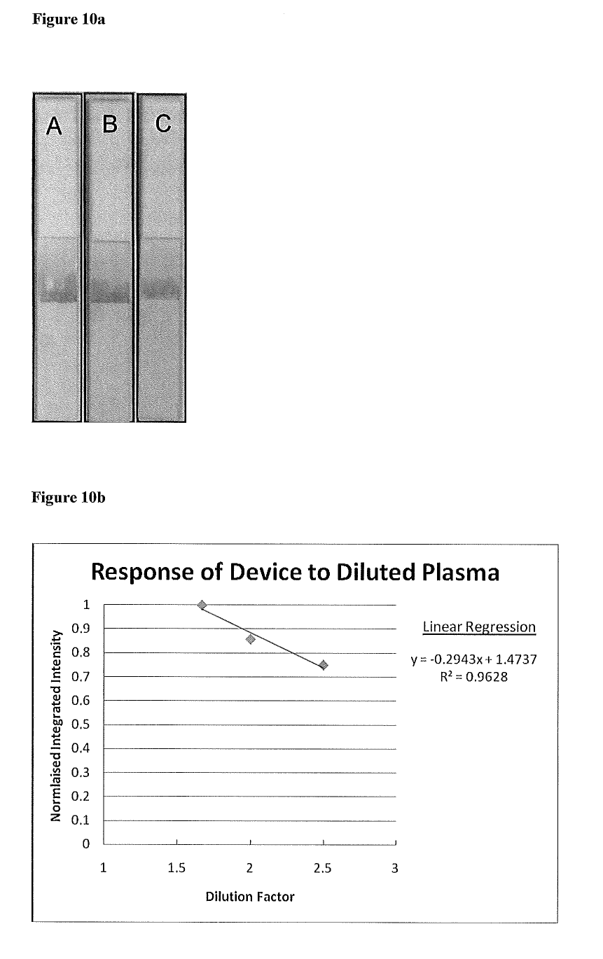

The preferred configuration of the device can be used to analyse human plasma at a range of dilutions from 3:2-2:3 dilution with buffer. Refer to FIG. 10a for photographic images of the device tested against diluted serum samples, and to FIG. 10b for a plot of the densitometrically determined chromophore intensity. The response of the device is linear within the dilution range tested.

Any discussion of the prior art throughout the specification should in no way be considered as an admission that such prior art is widely known or forms part of common general knowledge in the field.

Although the invention has been described by way of example, it should be appreciated that variations and modifications may be made without departing from the scope of the invention. Furthermore, where known equivalents exist to specific features, such equivalents are incorporated as if specifically referred to in the specification.

1. A device for detecting the presence of one or more antioxidants in a liquid sample, where the device comprises:
a) a matrix capable of supporting one or more chemical substances;
b) chemical A supported at a first location on the matrix;
c) chemical B supported at a second location on the matrix, where chemical B is capable of reacting with chemical A to give chemical C;
where the sample, when applied to the matrix, travels along or within the matrix to the first location, and then the sample and chemical A travel along or within the matrix to the second location where chemical A reacts with chemical B to give chemical C and where the one or more antioxidants in the sample react with chemical C to give chemical D, where the presence of chemical D can be detected.

2. A device for detecting the presence of one or more antioxidants in a liquid sample, where the device comprises:
a) a matrix capable of supporting one or more chemical substances;
b) chemical B supported at a first location on the matrix;
c) chemical A supported at a second location on the matrix, where chemical A is capable of reacting with chemical B to give chemical C;
where the sample, when applied to the matrix, travels along or within the matrix to the first location, and then the sample and chemical B travel along or within the matrix to the second location where chemical A reacts with chemical B to give chemical C and where the one or more antioxidants in the sample react with chemical C to give chemical D, where the presence of chemical D can be detected.

3. A device for detecting the presence of one or more antioxidants in a liquid sample, where the device comprises:
a) a matrix capable of supporting one or more chemical substances;
b) chemical B supported at a first location on the matrix;
c) chemical A supported at a second location on the matrix;
where the sample, when applied to the matrix, travels along or within the matrix to the first location, and then the sample and chemical B travel along or within the matrix to the second location where chemical A reacts first with the one or more antioxidants in the sample and then with chemical B to give chemical D, where the presence of chemical D can be detected.

4. A device for detecting the presence of one or more antioxidants in a liquid sample, where the device comprises:
a) a matrix capable of supporting one or more chemical substances;
b) chemical A supported at a first location on the matrix;
c) chemical B supported at a second location on the matrix;
where the sample, when applied to the matrix, travels along or within the matrix to the first location, and then the sample and chemical A travel along or within the matrix to the second location where chemical A reacts first with the one or more antioxidants in the sample and then with chemical B to give chemical D, where the presence of chemical D can be detected.

5. A device for detecting the presence of one or more antioxidants in a liquid sample, where the device comprises:
a) a matrix capable of supporting one or more chemical substances;
b) chemical A and chemical B supported at a first location on the matrix;
where the sample, when applied to the matrix, travels along or within the matrix to the first location, and then chemical A reacts first with the one or more antioxidants in the sample and then with chemical B to give chemical D, where the presence of chemical D can be detected.
